(19) United States
(12) Patent Application Publication
(10) Pub. No.: US 2005/0094773 A1
(43) Pub. Date: May 5, 2005

(54) CALEA application server complex

(75) Inventor: James D. Peterson, Phoenix, AZ (US)

Correspondence Address: Richard J. Minnich, Esq.;Fay, Sharpe, Fagan, Minnich & McKee, LLP, Seventh Floor, 1100 Superior Avenue, Cleveland, OH, 44114, US

(73) Assignee: Lucent Technologies Inc.

(21) Appl. No.: 10/698,802

(22) Filed: Oct. 31, 2003

(51) Int. Cl. H04M 1/24; H04M 3/08

(52) U.S. Cl. 379/35

(57) ABSTRACT

A method of conducting covert surveillance of a subject is provided for within a telecommunications network. The surveillance includes surveillance of a monitored call connected over the network, the monitored call being between the subject and an associate and including circuit-switched or packet-switched call content, i.e., bearer traffic exchanged between the subject and the associate. The method includes: clandestinely receiving the circuit-switched or packet-switched call content; converting the received circuit-switched call content into a packet-switched format; and, delivering the call content in the packet-switched format to a designated law enforcement agency over a packet-switched data network.

### FIELD

The present inventive subject matter relates to the telecommunication arts. Particular application is found in conjunction with class 5 telecommunications switches, and the specification makes particular reference thereto. However, it is to be appreciated that aspects of the present inventive subject matter are also amenable to other like applications.

### BACKGROUND

As is known in the art, the Communications Assistance for Law Enforcement Act (CALEA) prescribes the statutory obligations of a telecommunications carrier to assist a Law Enforcement Agency (LEA) in executing electronic surveillance pursuant to a court order or other lawful authorization. Under CALEA, the telecommunications carrier is generally obliged to provide a suitable means for LEAs to monitor the calls of telephone subscribers when the LEAs are duly authorized under the law to engage in such surveillance of the subscribers. CALEA simply seeks to ensure that after an LEA obtains the appropriate legal authority, the telecommunications carrier will have appropriate capability, and sufficient capacity, to assist the LEA regardless of their specific systems or services. Accordingly, various implementations have been developed to accommodate CALEA compliance.

In certain instances, for example, to achieve CALEA compliance, an Application Server Complex (ASC) or the like is implemented as an adjunct to a class 5 telecommunications switch, commonly maintained at a Central Office (CO) of the telecommunications network. That is to say, the ASC provides for the electronic surveillance and/or call monitoring by the LEA. The ASC and/or like facilities typically provide this surveillance in accordance with the technical specifications set forth in what is known as Standard J-STD-25, “Lawfully Authorized Electronic Surveillance,” developed jointly by the Telecommunications Industry Association (TIA) and Standards Committee T1-Telecommunications.

In general, the CALEA ASC is capable of receiving and immediately retransmitting to a designated LEA, two kinds of call information, namely: (i) call progress data and/or call identifying information; and (ii) call content. The call progress data/call identifying information refers to the dialling and/or signalling information that relates to and/or identifies the origin, direction, destination or termination of a call and other such information. The call content refers to the bearer traffic or information being transmitted via a call, e.g., the audio signal (such as speech) being transmitted via a circuit-switched communication or the data packets being transmitted via a packet-switched communication. For simplicity herein, the first type of information shall be referred to using the abbreviation CPD for call progress data, and the second type of information shall be referred to using the abbreviation CC for call content.

FIG. 1 shows an exemplary CALEA implementation in accordance with a commonly used network connection architecture. For the purpose of this example, a class 5 switch 10 provides service to a subject 20 that is properly under surveillance. The class 5 switch 10 incorporates a CALEA ASC 12. The ASC 12 selectively receives and retransmits to the LEA 30, call information related to the subject 20. In the case of packet-switch calls (e.g., data calls and the like), the packet data CC is transmitted to the LEA 30 over a packet-switched data network (PSDN) 40. Notably, in the case of circuit-switched calls (e.g., voice calls and the like), the circuit-switched CC is transmitted to the LEA 30 over a public switch telephone network (PSTN) 50, i.e., a circuit-switched network. In the case of both circuit and packet-switched calls, the CPD is transmitted to the LEA 30 over the PSDN 40 (as shown) or over the PSTN 50 using a packet-switched protocol over a dedicated channel. Typically, the CPD and packet data CC are delivered to the LEA 30 using a data channel (DC) arranged as a permanent virtual circuit (PVC), and circuit-switched CC is delivered to the LEA 30 using dedicated call content channels (CCCs). Generally, for a given surveillance, at least two dedicated CCCs are employed for retransmission of the circuit-switched CC, one for the transmitting leg and the other for the receiving leg of the subject under surveillance.

For surveillance of circuit-switch CC, the J-STD-25 specifies that circuit-switched CC is to be intercepted and delivered using only circuit-switched delivery. Accordingly, the connections between the ASC and the LEA commonly include dedicated circuit-switched facilities. In general, these connections are nailed connections going through one or more CO switches to telephone lines that terminate in the LEA's offices or monitoring facility. The connections are typically set up at the time the surveillance is established, and they remain dedicated exclusively to the surveillance of a given subject (for a given LEA) as long as the surveillance remains in effect. For example, these connections are kept open continually, even when the subject is not engaged in any calls. As can be appreciated by those skilled in the art, such an approach to the implementation of CALEA functionality tends to result in an inefficient allocation of resources because the facilities are dedicated full time but are typically used only a fraction of the time.

Accordingly, a new and improved CALEA architecture is disclosed that overcomes the above-referenced problems and others.

### SUMMARY

In accordance with one preferred embodiment, a method of conducting covert surveillance of a subject is provided for within a telecommunications network. The surveillance includes surveillance of a monitored call connected over the network, the monitored call being between the subject and an associate and including circuit-switched call content, i.e., bearer traffic exchanged between the subject and the associate. The method includes: clandestinely receiving the circuit-switched call content; converting the received circuit-switched call content into a packet-switched format; and, delivering the call content in the packet-switched format to a designated law enforcement agency over a packet-switched data network.

In accordance with another preferred embodiment, a system is provided within a telecommunications network for conducting covert surveillance of a subject. The surveillance includes surveillance of a monitored call connected over the network, the monitored call being between the subject and an associate and including circuit-switched call content, i.e., bearer traffic exchanged between the subject and the associate. The system includes: monitoring means for clandestinely receiving the circuit-switched call content; translation means for converting the received circuit-switched call content into a packet-switched format; and, transmission means for delivering the call content in the packet-switched format to a designated law enforcement agency.

Numerous advantages and benefits of the inventive subject matter disclosed herein will become apparent to those of ordinary skill in the art upon reading and understanding the present specification.

### BRIEF DESCRIPTION OF THE DRAWINGS

Preferred embodiments may take form in various components and arrangements of components, and in various steps and arrangements of steps. The drawings are only for purposes of illustrating preferred embodiments and are not to be construed as limiting. Further, it is to be appreciated that the drawings are not to scale.

FIG. 1 is diagrammatic illustration showing an exemplary CALEA implementation in accordance with a commonly used network connection architecture.

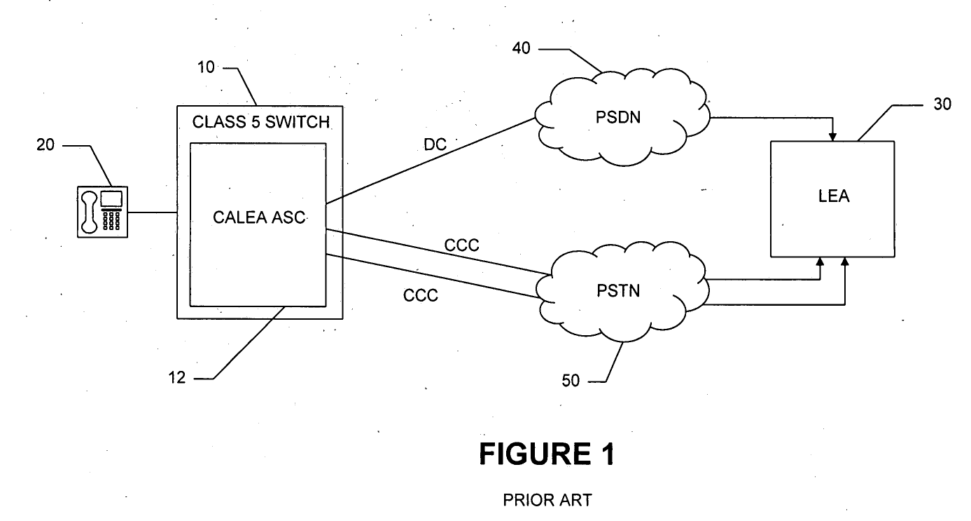

FIG. 2 is diagrammatic illustration showing a network connection architecture of a CALEA implementation in accordance with aspects of an exemplary embodiment of the present invention.

### DETAILED DESCRIPTION OF PREFERRED EMBODIMENTS

For clarity and simplicity, the present specification shall refer to structural and/or functional network elements, entities and/or facilities, relevant communications standards, protocols and/or services, and other components that are commonly known in the telecommunications art without further detailed explanation as to their configuration or operation except to the extent they have been modified or altered in accordance with and/or to accommodate the preferred embodiment(s) presented.

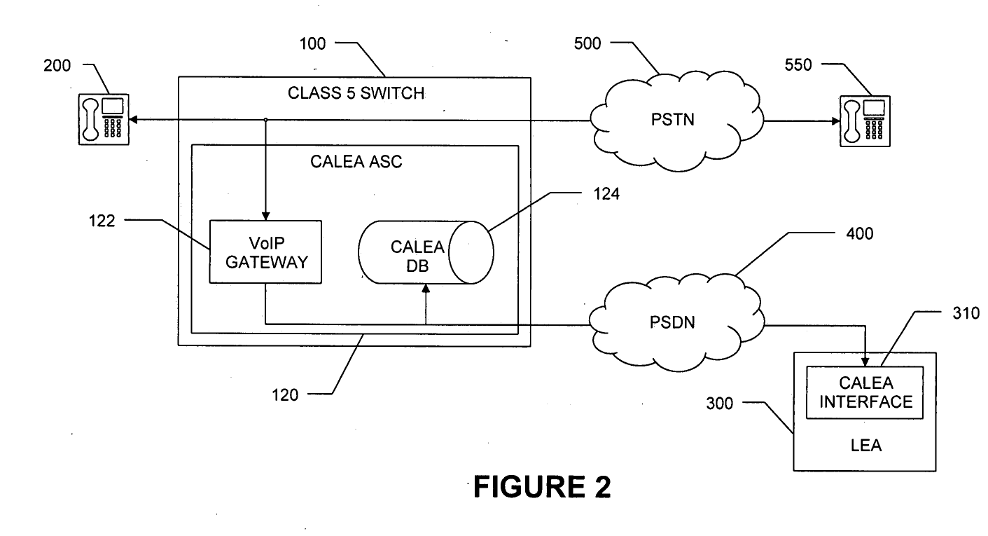

With reference to FIG. 2, an exemplary telecommunications system is illustrated in accordance with a preferred embodiment. A CALEA ASC 120 or other like facility is incorporated as an adjunct to a telecommunications switch 100, which is suitably a class 5 switch or other similar telecommunications switch and/or including packet-switching equipment, e.g., located at a CO of a telecommunications carrier. The switch 100 serves as the originating and/or terminating switch (i.e., at a local CO or end office) providing telephone service to a subscriber or subject 200, e.g., using a telephone or other customer premises equipment (CPE) to make calls. For illustrative purposes herein, the subject 200 shall be considered the subject under surveillance in accordance with CALEA by a duly authorized LEA 300. While only one such subject and one such LEA are illustrated, it is to be appreciated that one or more LEAs may be similarly situated, and each LEA may be conducting similar surveillance on one or more similarly situated subjects at any given time, and each subject may likewise be under surveillance by one or more LEAs at a given time.

Circuit-switched calls (e.g., voice calls) between the surveillance subject 200 and an associate or second party 550 (e.g., also a subscriber using a telephone or other CPE to communicate with the subject 200) are connected through the switch 100 and over the PSTN 500 in the usual manner. The surveillance subject's calls are monitored via the CALEA ASC 120 for so long as the surveillance remains in effect. Suitably, the call monitoring and/or surveillance conducted by the ASC 120 is substantially undetectable or unperceivable by the principals (i.e., the subject 200 and associate 550) engaged in the call. That is to say, from the perspective of the principals engaged in the call, the call appears to be the same regardless of whether the surveillance is being conducted or not.

Generally, there are two levels of surveillance which may selectively be carried out via the CALEA ASC 120, nominally termed level 1 and level 2. For level 1 surveillance, the CPD is obtained for calls to and/or from the surveillance subject 200. For level 2 surveillance, the CPD and CC are both obtained for calls to and/or from the surveillance subject 200.

Suitably, the ASC 120 is equipped or provisioned with a Internet Protocol (IP) gateway 122 or other equipment to convert the CC to packet-switched format. The gateway 122 converts and/or translates the circuit-switched CC into a packet-switched format. For example, the circuit-switched CC captured, intercepted or otherwise received by the ASC 120 is converted and/or translated by the gateway 122 into a Voice over IP (VOIP) format. That is to say, the ASC 120 captures, intercepts or otherwise receives the circuit-switched CC from a call between the subject 200 and the associate 550. The received circuit-switched CC is converted into a VolP format or other like packet-switched call format by the gateway 122. It is then deliverable to the LEA 300 over a PSDN 400. Optionally, the ASC 120 is also equipped or provisioned with a database (DB) or similar storage device 124, e.g., implemented via a memory, hard drive, magnetic or optical storage, etc. The CPD and/or CC obtained by the ASC-120 is selectively stored and/or maintained in the CALEA DB 124. On the LEA end, the LEA facilities are optionally provisioned with an interface 310 that provides suitable access to the CALEA ASC 120, and in particular, the CALEA DB 124.

In general, the ASC's system and network architecture has been enhanced to provide a packet-switched communication and/or interface for CC between the ASC 120 and the LEA 300. The packet interface supports delivery of both the CPD and CC to the LEA 300, even for circuit-switched calls. Optionally, it is provided as either a dedicated packet-switched network interface or, with suitable security arrangements, a connection via a shared or public packet network (e.g., the Internet) or a virtual private network (VPN). For analog or circuit-switched CC (e.g., voice), the CC is packetized and retransmitted over this packet interface via standard protocols, e.g., those commonly used for VolP services.

As will be appreciated by those of ordinary skill in the art, the present architecture has the potential of providing significant savings in the costs of surveillance for at least two reasons:
i) the transmission capacity on this packet-switched interface is preferably used intermittently only when desired—i.e., when a surveillance subject is engaged in a telephone call—thus, the capacity is shared among many subjects and LEAs; and,
ii) due to the technologies involved (e.g., Ethernet, fiber optics, etc.), the costs of packet-switched transmission facilities, per unit of capacity, are generally significantly lower than those of comparable circuit-switched facilities.

Optionally, the retransmission of digitalized analog CC (such as speech) via the packet-switched interface between the ASC 120 and the LEA 300 is implemented using data compression and streaming techniques, thereby enhancing the bandwidth efficiency even further.

Suitably, as already mentioned, the ASC 120 is provisioned with a DB 124 that provides local storage, within the ASC 120, of surveillance data (e.g., the CPD, the CC or both). A secure mechanism is also provided (via the interface 310) whereby authorized LEA personnel are able to retrieve this stored surveillance data over the PSDN 400. The LEA 300 is therefore given an option to obtain the surveillance data in real-time (i.e., as monitored calls occur) or at a later time (e.g., either a designated time or on demand). This provides additional potential cost savings for the LEA 300 because monitoring personnel will not have to be on duty continually to monitor all the calls in real-time, and because LEA personnel will be able to handle more surveillance operations per individual. Suitably, the local storage within the ASC 120 also serves as a back-up to surveillance data storage at the LAE facilities. That is to say, the ASC's local storage capability selectively acts as a backup or fail-safe mechanism, so that if the transmission facilities to the LEA 300 fail or become overloaded, or the monitoring equipment within the LEA's offices fails (e.g., due to equipment problems or a power outage), the ASC 120 can still retain a copy of the surveillance data for later retrieval by, and/or delivery to, the LEA 300.

As an optional addition to the architecture, a mechanism for the LEA 300 to access stored surveillance data in the DB 124 via a traditional circuit-switched network interface is also included. For example, to use this circuit-switched interface, the LEA personnel (or collection equipment) dials a specified access phone number, and then interacts with an Integrated Voice Response (IVR) interface. Suitably, the IVR prompts the caller to logon (e.g., by entering a user ID and security code or password), and to select the stored surveillance data to be accessed (e.g., via the entry of DTMF digits). Optionally, to hear the stored CC over the circuit-switched interface, the packetized data from the DB 124 is reverse routed through the gateway 122 to restore it to the circuit-switch CC originally received by the ASC 120.

Suitably, the ASC 120 is also enhanced to provide access via a standard, Internet-like interface 310 employed by the LEA personnel and/or their monitoring equipment. The interface 310 is preferably implemented with security features (e.g., user IDs, passwords, encryption, etc.) to prevent unauthorized access. It optionally enables the LEA 300 to use inexpensive and readily available equipment (e.g., personal computers) and software (e.g., VPN tools, web browsers, etc.) to monitor the subject 200 in real-time as well as to download or access stored surveillance-data from the DB 124. Alternatively, a customized LEA surveillance software application is readily deployable for use by the LEA personnel over the interface 310. The customized application optionally support both the real-time monitoring and downloading functions, and potentially provides a safer and less error-prone human interface for LEA personnel than standard, publicly available software packages, e.g., such as web browsers.

It is to be appreciated that in connection with the particular exemplary embodiments presented herein certain structural and/or function features are described as being incorporated in defined elements and/or components. However, it is contemplated that these features may, to the same or similar benefit, also likewise be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that particular elements or components described herein may have their functionality suitably implemented via hardware, software, firmware or a combination thereof. Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to preferred embodiments. Obviously, modifications and alterations will occur to others upon reading and understanding the present specification. It is intended that the invention be construed as including all such modifications and alterations insofar as they come within the scope of the appended claims or the equivalents thereof.

1. Within a telecommunications network, a method of conducting covert surveillance of a subject, said surveillance including surveillance of a monitored call connected over the network, said call being between the subject and an associate and including call progress data as well as circuit-switched or packet-switched call content comprising bearer traffic exchanged between the subject and the associate, said method comprising:
(a) clandestinely receiving the circuit-switched call content;
(b) converting the received circuit-switched call content into a packet-switched format; and,
(c) delivering the call content in the packet-switched format to a designated law enforcement agency over a packet-switched data network.

2. The method of claim 1, wherein step (c) further comprises:
transmitting the received call content to the law enforcement agency in substantially real-time while the monitored call is in progress.

3. The method of claim 1, further comprising:
storing the received call content prior to step (c).

4. The method of claim 3, wherein step (c) further comprises:
providing the law enforcement agency with access to the stored call content; and,
transmitting the stored call content and call progress data to the law enforcement agency upon receipt of a request therefor from the law enforcement agency.

5. The method of claim 1, further comprising:
storing the received call content; and,
providing the law enforcement agency with access to the stored call content; and,
step (c) further comprises both: (i) transmitting the received call content to the law enforcement agency in substantially real-time while the monitored call is in progress; and, (ii) transmitting the stored call content to the law enforcement agency upon receipt of a request therefor from the law enforcement agency.

6. The method of claim 1, further comprising:
applying data compression to the received call content in the packet-switched format.

7. The method of claim 1, further comprising:
obtaining the call progress data; and,
storing the call progress data.

8. Within a telecommunications network, a system for conducting covert surveillance of a subject, said surveillance including surveillance of a monitored call connected over the network, said monitored call being between the subject and an associate and including circuit-switched or packet-switched call content comprising bearer traffic exchanged between the subject and the associate, said system comprising:
monitoring means for clandestinely receiving the circuit-switched or packet-switched call content;
translation means for converting the received circuit-switched call content into a packet-switched format; and,
transmission means for delivering the call content in the packet-switched format to a designated law enforcement agency.

9. The system of claim 8, wherein the transmission means transmits the received call content to the law enforcement agency in substantially real-time while the monitored call is in progress.

10. The system of claim 9, further comprising:
storage means for storing the received call content prior to delivery by the transmission means.

11. The system of claim 10, further comprising:
interface means for providing the law enforcement agency with access to the storage means to selectively obtain the stored call content therefrom; and,
wherein the transmission means transmits the stored call content to the law enforcement agency upon receipt of a request therefor from the law enforcement agency.

12. The system of claim 8, further comprising:
storage means for storing the received call content; and,
interface means for providing the law enforcement agency with access to the storage means to selectively obtain the stored call content therefrom; and,
wherein the transmission means both: (i) transmits the received call content to the law enforcement agency in substantially real-time while the monitored call is in progress; and, (ii) transmits the stored call content to the law enforcement agency upon receipt of a request therefor from the law enforcement agency.

13. The system of claim 8, wherein the transmission means comprises a packet-switched data network.

14. The system of claim 8, wherein the translation means comprises a packet-switched gateway.

15. The system of claim 8, wherein the monitoring means comprises an application server complex implemented as an adjunct to a telecommunications switch providing service to the subscriber.
